(19) United States
(12) Patent Application Publication
(10) Pub. No.: US 2017/0178792 A1
(43) Pub. Date: Jun. 22, 2017

(54) VOLTAGE TRANSFORMER

(71) Applicants: DARFON ELECTRONICS (SUZHOU) CO., LTD., Suzhou (CN); DARFON ELECTRONICS CORP., TAOYUAN CITY (TW)

(72) Inventors: CHIN-LUNG YANG, TAOYUAN CITY (TW); SHENG-WEN HUANG, TAOYUAN CITY (TW); WEN-JUI CHIANG, TAOYUAN CITY (TW)

(73) Assignees: DARFON ELECTRONICS (SUZHOU) CO., LTD., Suzhou (CN); DARFON ELECTRONICS CORP., TAOYUAN CITY (TW)

(21) Appl. No.: 15/295,208

(22) Filed: Oct. 17, 2016

(30) Foreign Application Priority Data
Dec. 18, 2015 (TW) 104142819

(51) Int. Cl. H01F 27/28; H01F 27/24; H01F 27/32

(52) U.S. Cl. CPC H01F 27/2823; H01F 27/324; H01F 27/24

(57) ABSTRACT

A voltage transformer includes a magnetic core body, a positioning plate, a first coil, and a second coil. The magnetic core body has an accommodation space and a rod portion extending along a Z axis. The positioning plate extends along an X-Y plane and has a first end portion, a second end portion, and a positioning hole. The first end portion has a first A hole; the second end portion has a first B hole; the rod portion penetrates through the positioning hole. The first coil has a first winding portion, a first A wire portion, and a first B wire portion. The first winding portion is accommodated in the accommodation space and extends substantially along the X-Y plane. The rod portion penetrates through the first winding portion. The second coil has a second winding portion and a second wire portion. The second winding portion is accommodated in the accommodation space and extends substantially along the X-Y plane. The rod portion penetrates through the second winding portion. The second wire portion protrudes toward the second end portion out of the magnetic core body. The first A wire portion penetrates through the first A hole and the first B wire portion penetrates through the first B hole.

### BACKGROUND OF THE INVENTION

1. Field of the Invention

The present invention generally relates to a voltage transformer.

2. Description of the Prior Art

With the progress and development of electronic devices, different voltages and currents are used to drive different electronic devices. Thus, the manufacturers of power suppliers continuously develop various voltage transformer structures to be applied to different power suppliers.

As a conventional voltage transformer 11 shown in FIG. 1, it is usually composed of one or more primary winding(s), one or more supplementary winding(s), and one or more secondary winding(s).

For the purpose of safety insulation or isolation, tapes are usually used during winding, hence the costs of wrapping material and labor are increased. On the other hand, because the winding is often completed manually, the stability in quality and the leakage inductance could be improved.

### SUMMARY OF THE INVENTION

An object of the present invention is to provide a voltage transformer for reducing the wrapping material required for achieving safe insulation.

Another object of the present invention is to provide a voltage transformer having a better stability in quality.

Another object of the present invention is to provide a voltage transformer having less leakage inductance.

The voltage transformer includes a magnetic core body, a positioning plate, a first coil, and a second coil. The magnetic core body has an accommodation space and a rod portion extending along a Z axis. The rod portion is surrounded with the accommodation space. The positioning plate extends along an X-Y plane and has a first end portion, a second end portion, and a positioning hole, wherein the first end portion has a first A hole and a first B hole. The rod portion penetrates through the positioning hole. The X axis of the X-Y plane, the Y axis of the X-Y plane, and the Z axis are perpendicular to each other. The first coil has a first winding portion, a first A wire portion, and a first B wire portion. The first winding portion is accommodated in the accommodation space and extends substantially along the X-Y plane. The rod portion penetrates through the first winding portion. The second coil has a second winding portion and a second wire portion. The second winding portion is accommodated in the accommodation space and extends substantially along the X-Y plane. The rod portion penetrates through the second winding portion. The second wire portion protrudes toward the second end portion out of the magnetic core body. The first A wire portion has a first A upper extending portion adjacent to the first winding portion and a first A lower extending portion penetrating through the first A hole. A first angle is included between the first A upper extending portion and the first A lower extending portion. The first B wire portion has a first B upper extending portion adjacent to the first winding portion and a first B lower extending portion penetrating through the first B hole. A second angle is included between the first B upper extending portion and the first B lower extending portion.

The first A upper extending portion extends substantially along the X-Y plane. The first lower A extending portion extends substantially along the Z axis. The first angle between the first A upper extending portion and the first A lower extending portion is approximately 90 degrees. The voltage transformer further includes a third coil having a third winding portion, a third A wire portion, and a third B wire portion. The third winding portion is accommodated in the accommodation space and extends substantially along the X-Y plane. The rod portion penetrates through the third winding portion. The third A wire portion has a third A upper extending portion adjacent to the third winding portion and a third A lower extending portion penetrating through the first A hole. A third angle is included between the third A upper extending portion and the third A lower extending portion. The third B wire portion has a third B upper extending portion adjacent to the third winding portion and a third B lower extending portion penetrating through the first B hole. A fourth angle is included between the third B upper extending portion and the third B lower extending portion.

The first A, the first B, the third A, and the third B upper extending portions all extend substantially along the X axis. The projections of the first A and the third A upper extending portions in the direction of the Z axis at least partially overlap. The projections of the first B and the third B upper extending portions in the direction of the Z axis at least partially overlap. The first A, the first B, the third A, and the third B lower extending portions all extend substantially along the Z axis. The projections of the first A and the third A lower extending portions in the direction of the X axis at least partially overlap. The projections of the first B and the third B lower extending portions in the direction of the X axis at least partially overlap.

The first A and the third A lower extending portions are welded together under the positioning plate after penetrating through the first A hole. The first B and the third B lower extending portions are welded together under the positioning plate after penetrating through the first B hole. The first winding portion and the third winding portion are connected in parallel.

The middle parts of the first A and the third A lower extending portions are fixed on the positioning plate by adhesive material after the first A and the third A lower extending portions penetrate through the first A hole. The middle parts of the first B and the third B lower extending portions are fixed on the positioning plate by adhesive material after the first B and the third B lower extending portions penetrate through the first B hole.

The first A wire portion extends along the X-Z plane, wherein projection of the first A wire portion on the X-Z plane has a first L shape. The third A wire portion extends along the X-Z plane, wherein projection of the third A wire portion on the X-Z plane has a second L shape. The length of the third A upper extending portion is larger than the length of the first A upper extending portion. The length of the third A lower extending portion is larger than the length of the first A lower extending portion. The location of the third winding portion is higher than the location of the first winding portion in the accommodation space for the third A wire portion to extend above and outside the first A wire portion, so that the first L shape and the second L shape have substantial bending angles.

The voltage transformer further includes a fourth coil having a fourth winding portion, a fourth A wire portion, and a fourth B wire portion. The fourth winding portion is accommodated in the accommodation space and extends substantially along the X-Y plane. The rod portion penetrates through the fourth winding portion. The first end portion further has a third A hole and a third B hole. The fourth A wire portion has a fourth A upper extending portion adjacent to the fourth winding portion and a fourth A lower extending portion penetrating through the third A hole, wherein a fifth angle is included between the fourth A upper extending portion and the fourth A lower extending portion. The fourth B wire portion has a fourth B upper extending portion adjacent to the fourth winding portion and a fourth B lower extending portion penetrating through the third B hole, wherein a sixth angle is included between the fourth B upper extending portion and the fourth B lower extending portion.

The first A, the first B, the fourth A, and the fourth B upper extending portions all extend substantially along the X axis. The projections of the first A and the fourth A upper extending portions in the direction of the Z axis at least partially overlap. The projections of the first B and the fourth B upper extending portions in the direction of the Z axis at least partially overlap. The first A, the first B, the fourth A, and the fourth B lower extending portions all extend substantially along the Z axis. The projections of the first A and the fourth A lower extending portions in the direction of the X axis at least partially overlap. The projections of the first B and the fourth B lower extending portions in the direction of the X axis at least partially overlap.

The first A and the fourth A lower extending portions are welded together under the positioning plate after penetrating respectively through the first A hole and the third A hole. The first B and the fourth B lower extending portions are welded together under the positioning plate after penetrating respectively through the first B hole and the third B hole. The first winding portion and the fourth winding portion are connected in parallel.

The middle parts of the first A and the fourth A lower extending portions are fixed on the positioning plate by adhesive material after the first A and the fourth A lower extending portions penetrate respectively through the first A hole and the third A hole. The middle parts of the first B and the fourth B lower extending portions are fixed on the positioning plate by adhesive material after the first B and the fourth B lower extending portions penetrate respectively through the first B hole and the third B hole.

The first A wire portion extends along the X-Z plane, wherein the projection of the first A wire portion on the X-Z plane has a first L shape. The fourth A wire portion extends along the X-Z plane, wherein the projection of the fourth A wire portion on the X-Z plane has a third L shape. The length of the fourth A upper extending portion is larger than the length of the first A upper extending portion. The length of the fourth A lower extending portion is larger than the length of the first A lower extending portion. The location of the fourth winding portion is higher than the location of the first winding portion in the accommodation space for the fourth A wire portion to extend above and outside the first A wire portion, so that the first L shape and the third L shape have a substantially same bending angles.

The second winding portion includes a first-layered structure and a second-layered structure in the direction of the Z axis, wherein the second coil is wound by: (1) winding an insulated wire on the X-Y plane to form the first-layered structure with, wherein an inner rim of the first laminate structure is aligned with an inner rim of the first winding portion, wherein an outer rim of the first-layered structure is close to an outer rim of the first winding portion; and (2) changing position of the tail of the insulated wire in the direction of the Z axis to wind the second-layered structure, wherein an inner rim of the second-layered structure is aligned with an inner rim of an first winding portion, wherein an outer rim of the second-layered structure is close to an outer rim of the first winding portion.

Taking a different point of view, the voltage transformer includes a magnetic core body, a positioning plate, a first coil set, and a second coil set. The magnetic core body has an accommodation space and a rod portion extending along a Z axis. The rod portion is surrounded with the accommodation space. The positioning plate extends along an X-Y plane and has a first end portion, a second end portion, and a positioning hole, wherein the first end portion has two first holes. The rod portion penetrates through the positioning hole. The X axis of the X-Y plane, the Y axis of the X-Y plane, and the Z axis are perpendicular to each other. The first coil set includes at least one first coil, wherein each first coil has a first winding portion and a first wire portion. The first winding portion is accommodated in the accommodation space and extends substantially along the X-Y plane. The rod portion penetrates through the first winding portion. The first wire portion has a first part and a second part, wherein an angle is included between the first part and the second part. The second part penetrates through the first hole. The second coil set includes at least one second coil, wherein each second coil has a second winding portion and a second wire portion. The second winding portion is accommodated in the accommodation space and extends substantially along the X-Y plane. The rod portion penetrates through the second winding portion. The second wire portion protrudes toward the second end portion out of the magnetic core body.

The difference between the inner and outer radiuses of the first coil set is d₁, wherein the difference between the inner and outer radiuses of the second coil set is d₂, the absolute value of d₁ minus d₂ (|d₁−d₂|) is less than 1.5 mm. The first coil set consists of M insulated flat wire coils. The second coil set consists of N trilayer insulated wire coils. M and N are positive integers. The M insulated flat wire coils and the N trilayer insulated wire coils are alternatively arranged. The first wire portions of the M insulated flat wire coils are overlapped, wherein M is larger than 1. The M insulated flat wire coils are electrically connected in parallel, wherein M is larger than 1.

The second end portion has a plurality of second holes. The terminal ends of the second winding portion penetrate through the plurality of second holes. A safety insulation distance is maintained between the second hole and the magnetic coil. The magnetic core body includes a first magnetic core and a second magnetic core both having an E-shaped profile. The first coil is formed by an insulated flat wire coil. The second coil set is trilayer insulated wire. The angle between the first part and the second part is approximately 90 degrees.

The second winding portion includes a first-layered structure and a second-layered structure in the direction of the Z axis, wherein the second coil is wounded by: (1) winding an insulated wire on the X-Y plane to form the first-layered structure, wherein an inner rim of the first-layered structure is aligned with an inner rim of the first winding portion, wherein an outer rim of the first-layered structure is aligned with an outer rim of the first winding portion; and (2) changing position of the tail of the insulated wire in the direction of the Z axis to wind the second-layered structure, wherein an inner rim of the second-layered structure is aligned with an inner rim of the first winding portion, wherein an outer rim of the second-layered structure is close to an outer rim of the first winding portion.

### BRIEF DESCRIPTION OF THE DRAWINGS

FIG. 1 illustrates a conventional voltage transformer;

FIGS. 2A and 2B illustrate an embodiment of the voltage transformer of the present invention;

FIG. 2C illustrates an embodiment of the second coil of the voltage transformer of the present invention;

FIG. 3 illustrates a cross-sectional view of an embodiment of the voltage transformer of the present invention;

FIG. 4 illustrates an embodiment of the voltage transformer of the present invention; and

FIG. 5 illustrates an embodiment of the voltage transformer of the present invention from a different point of view.

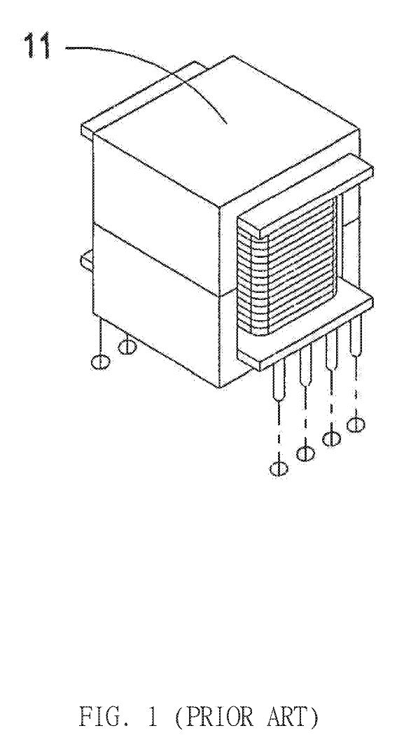

### DETAILED DESCRIPTION OF THE PREFERRED EMBODIMENT

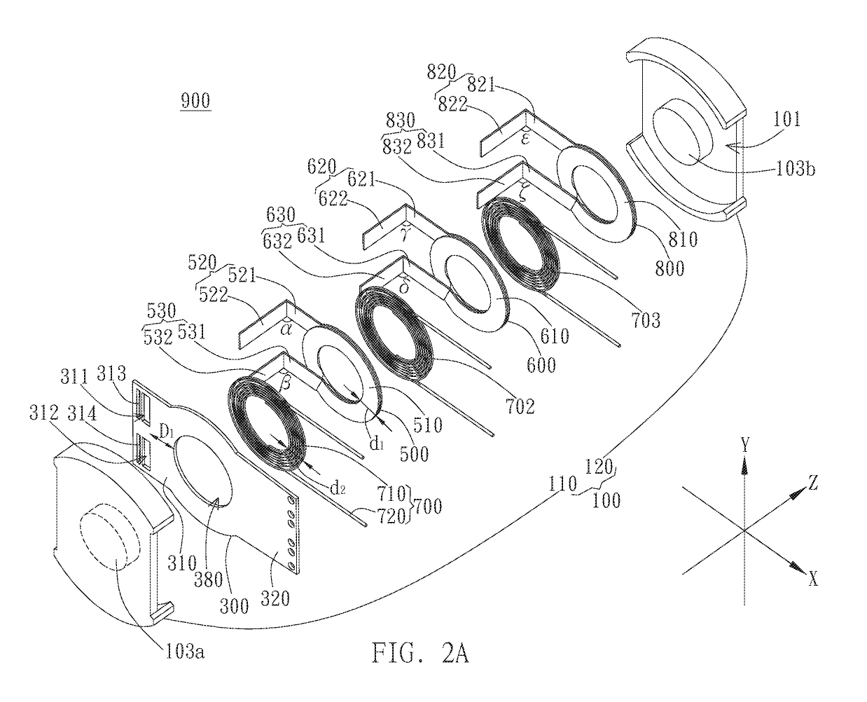

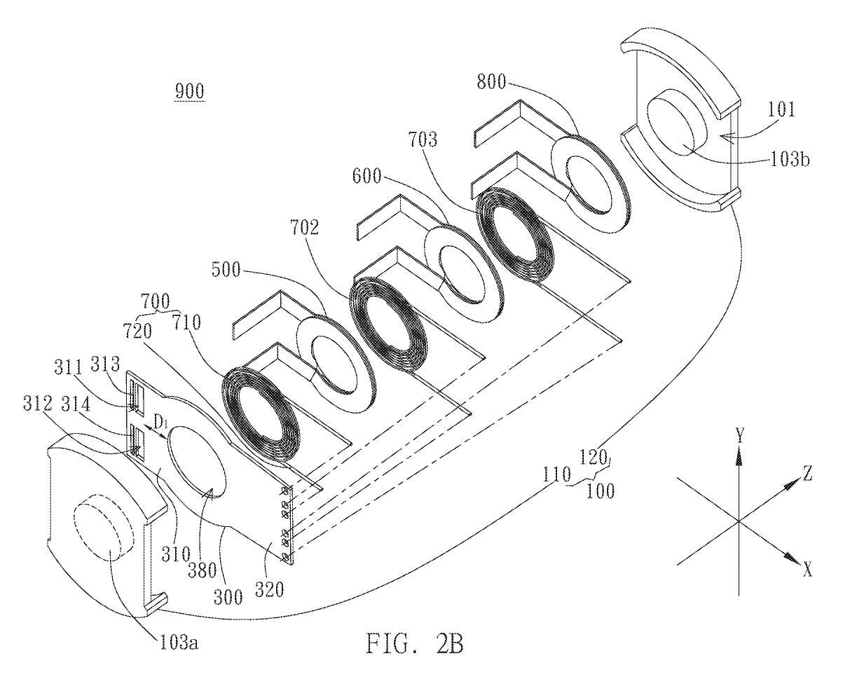

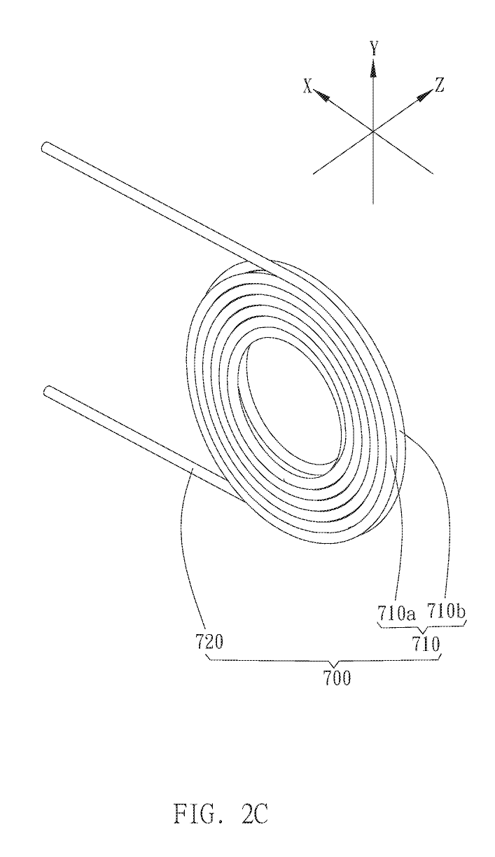

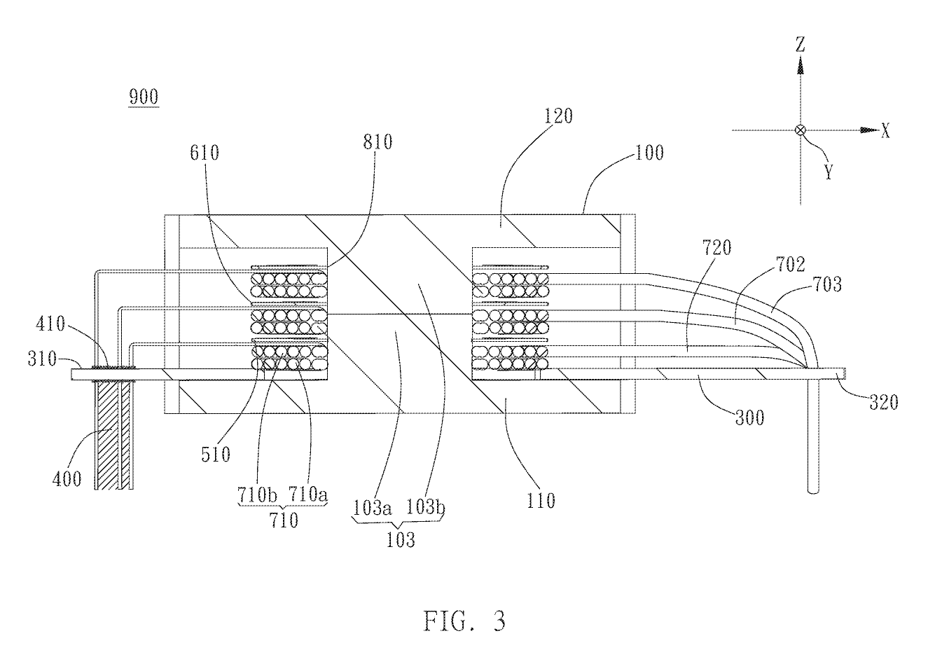

The voltage transformer of the present invention can be a step-up or a step-down voltage transformer. As an embodiment shown in FIGS. 2A and 3, the voltage transformer 900 includes a magnetic core body 100, a positioning plate 300, a first coil 500, and a second coil 700. The magnetic core body 100 has an accommodation space 101 and a rod portion 103 extending along a Z axis. The rod portion 103 is surrounded with the accommodation space 101. More particularly, as shown in FIG. 2A, the magnetic core body 100 is composed of magnetic cores 110 and 120, wherein magnetic cores 110 and 120 have pillars 103a and 103b, respectively. The magnetic cores 110 and 120 both have an E-shaped cross section cutting along the Y axis through the pillars 103a and 130b. When the pillars 103a and 103b of the magnetic cores 110 and 120 abut upon each other, the pillars 103a and 103b together form the rod portion 103, wherein the space surrounds the rod portion 103 between the magnetic cores 110 and 120 is the accommodation space 101.

As shown in FIG. 2A, the positioning plate 300 extends along an X-Y plane and has a first end portion 310, a second end portion 320, and a positioning hole 380, wherein the first end portion 310 has a first A hole 311 and a first B hole 312. As shown in FIG. 3, the rod portion 103 penetrates through the positioning hole 380. The X axis of the X-Y plane, the Y axis of the X-Y plane, and the Z axis are perpendicular to each other. More particularly, the positioning plate 300 surrounds the rod portion 103 via positioning hole 380. That is, the positioning plate 300 is disposed on the magnetic core 110 by inserting the pillar 103a into the positioning hole 380, wherein the first end portion 310 and the second end portion 320 of the positioning plate 300 respectively extend out of the accommodation space 101 along a plane perpendicular to the axial direction of the rod portion 103, i.e. the X-Y plane. That is, the first end portion 310 and the second end portion 320 respectively extend out of the magnetic core body 100 from two opposite sides on the X axis, and the normal to the plate surface of the positioning plate 300 is parallel to the axial direction of the rod portion 103 of the magnetic core body 100, i.e. the Z axis.

As shown in FIG. 2A, the first coil 500 has a first winding portion 510, a first A wire portion 520, and a first B wire portion 530. The first A wire portion 520 has a first A upper extending portion 521 adjacent to the first winding portion 510 and a first A lower extending portion 522 penetrating through the first A hole 311. A first angle α is included between the first A upper extending portion 521 and the first A lower extending portion 522. The first B wire portion 530 has a first B upper extending portion 531 adjacent to the first winding portion 510 and a first B lower extending portion 532 penetrating through the first B hole 312. A second angle β is included between the first B upper extending portion 531 and the first B lower extending portion 532. As shown in FIG. 3, the first winding portion 510 is accommodated in the accommodation space 101 and extends substantially along the X-Y plane. The rod portion 103 penetrates through the first winding portion 510. In a preferred embodiment, the first A upper extending portion 521 extends substantially out of the accommodation space 101 along the X-Y plane and the first A lower extending portion 522 extends substantially along the z axis, wherein the angle α between the first A upper extending portion 521 and the first A lower extending portion 522 is approximately 90 degrees. The first B upper extending portion 531 extends substantially out of the accommodation space 101 along the X-Y plane and the first B lower extending portion 532 extends substantially along the z axis, wherein the angle β between the first B upper extending portion 531 and the first B lower extending portion 532 is approximately 90 degrees. In different embodiments, however, the angles α, β can be any suitable angle other than 90 degrees in accordance with the manufacturing and design requirements.

More particularly, the first coil 500 is a coil wound by an insulated flat wire, wherein the wound portion is the first winding portion 510 and the opposite end portions extending from the wound portion are respectively the first A wire portion 520 and the first B wire portion 530. The first A wire portion 520 and the first B wire portion 530 extend respectively out of the accommodation space 101 along the plane perpendicular to the axial direction of the rod portion 103, bend respectively toward the positioning plate 300 to form the angles α and β, and then penetrate respectively through the first A hole 311 and the first B hole 312.

As shown in FIG. 2A, the second coil 700 has a second winding portion 710 and at least one second wire portion 720. As shown in FIGS. 2B and 3, the second winding portion 710 is accommodated in the accommodation space 101 and extends substantially along the X-Y plane. The rod portion 103 penetrates through the second winding portion 710. The second wire portion 720 protrudes toward the second end portion 320 out of the magnetic core body 100. More particularly, the second coil 700 is a coil wound by an insulated wire, wherein the wound portion is the second winding portion 710 and two end portions extending from the wound portion are the second wire portions 720. The second wire portion 720 extends out of the accommodation space 101 along the plane perpendicular to the axial direction the rod portion 103. As shown in FIGS. 2C and 3, for less leakage inductance, the second coil 700 is wound as a multi-layered structure by an insulated wire, wherein each layered structure is constructed by a plurality of rings. As the embodiment shown in FIGS. 2C and 3, the second winding portion 710 includes a 2-layered structure along the Z axis. For example, the second coil 700 is wound by: (1) winding a trilayer insulated wire on the X-Y plane to form the first-layered structure 710a, wherein the inner rim of the first-layered structure 710a is aligned with the inner rim of the first winding portion 510, wherein the outer rim of the first-layered structure 710a is as close as possible to the outer rim of the first winding portion 510; and (2) changing the position of the tail of the trilayer insulated wire in the direction of the Z axis to wind the second-layered structure 710b from inside to outside, wherein the inner rim of the second-layered structure 710b is aligned with the inner rim of the first winding portion 510, wherein the outer rim of the second-layered structure 710b is close to the outer rim of the first winding portion 510. In other words, the tail of the trilayer insulated wire holds its position corresponding to the Z axis, and the trilayer insulated wire is wound from inside to outside on the X-Y plane till the surrounded area of the first-layered structure 710a is as close as possible to the surrounded area of the first winding portion 510 (the inner rims of the two are aligned and the outer rims of the two are as close as possible). Afterwards, the other tail of the trilayer insulated wire changes its position corresponding to the Z axis and the trilayer insulated wire is wound from inside to outside on the X-Y plane till the surrounded area of the second-layered structure 710b is as close as possible to the surrounded area of the first winding portion 510.

After extending out of the accommodation space 101 along the plane perpendicular to the axial direction of the rod portion 103, the first A wire portion 520 and the first B wire portion 530 of the first coil 500 bend respectively toward the positioning plate 300, thus making the first A lower extending portion 522 and the first B lower extending portion 532 penetrate through the first A hole 311 and the first B hole 312 of the positioning plate 300, respectively. Since the distance D₁ of the first A hole 311 and the first B hole 312 with respect to the rod portion 103 that penetrates through the positioning hole 380 of the positioning plate 300 is fixed, it helps to ensure the distance of the first A lower extending portion 522 and the first B lower extending portion 532 with respect to the magnetic core body 100 to achieve a safety insulation distance and to leave out or reduce the wrapping material used on the first A wire portion 520 and the first B wire portion 530. Moreover, because both (a) the insulated flat wire coil of first coil 500 and (b) the trilayer insulated wire coil of the second coil 700 in the present invention are pre-wound by machines, the shape and size are more uniform compared to those manually wound coils in the prior art. Accordingly, the assembled voltage transformer 900 of the present invention has a better stability in quality.

The insulated flat wire coil of first coil 500 can be manufactured by the following steps. At first, a round copper wire is processed to form a flat wire. Afterward, the flat wire is bent to have required turns (or rings) by a winding tool. In the end, the end portions of the flat wire are bent by a bending tool to form the L-shaped first A wire portion 520 and the L-shaped first B wire portion 530. The purpose of using the insulated flat wire is to maximize the cross section area of the copper wire, hence to increase the upper limit of the current that can be handled by the first coil 500 and to improve the heat dissipation efficiency of the first coil 500.

Because the voltage transformer of the present invention is suitable for the use cross the AC and DC ends, there is a requirement regarding the insulation distance between the coil of AC end and the coil of DC end in accordance with the safety code. The safety distance can be satisfied by the usage of an insulation tape. Accordingly, regarding the trilayer insulated wire coil used in the second coil 700 of the present invention, the trilayer insulated wire is UL qualified and has a voltage-endurance for being used cross the AC and DC ends.

On the other hand, in a preferred embodiment, the first winding portion 510 and the second winding portion 710 are substantially overlapped. More particularly, as shown in FIG. 2A, when the inner radiuses of the first winding portion 510 and the second winding portion 710 are the same, there are a difference d₁ between the inner radius and the outer radius of the first winding portion 510 and a difference d₂ between the inner radius and the outer radius of the second winding portion 710, wherein the absolute value of d₁ minus d₂ is less than 1.5 mm, i.e. |d₁−d₂|<1.5 mm. Accordingly, the difference between the outer radiuses of the first winding portion 510 and the second winding portion 710 is controlled to decrease leakage inductance. In different embodiments, when the outer radiuses of the first winding portion 510 and the second winding portion 710 are the same, the difference between the inner radiuses of the first winding portion 510 and the second winding portion 710 is controlled to decrease leakage inductance.

In different embodiments, the number and arrangement of the coils in the voltage transformer of the present invention can be modified in accordance with the manufacturing and design requirements. For example, as the embodiment shown in FIG. 2A, the voltage transformer 900 further includes a third coil 600 having a third winding portion 610, a third A wire portion 620, and a third B wire portion 630. As shown in FIG. 3, the third winding portion 610 is accommodated in the accommodation space 101 and extends substantially along the X-Y plane, i.e. winding along the X-Y plane. The rod portion 103 penetrates through the third winding portion 610. The third A wire portion 620 has a third A upper extending portion 621 adjacent to the third winding portion 610 and a third A lower extending portion 622 penetrating through the first A hole 311. A third angle γ is included between the third A upper extending portion 621 and the third A lower extending portion 622. The third B wire portion 630 has a third B upper extending portion 631 adjacent to the third winding portion 610 and a third B lower extending portion 632 penetrating through the first B hole 312. A fourth angle δ is included between the third B upper extending portion 631 and the third B lower extending portion 632.

More particularly, the third coil 600 is also a coil wound by an insulated flat wire, wherein the wound portion is the third winding portion 610 and the opposite ends extending from the wound portion are the third A wire portion 620 and the third B wire portion 630, respectively. The third A wire portion 620 and the third B wire portion 630 extend respectively out of the accommodation space 101 along the plane perpendicular to the axial direction of the rod portion 103, bend respectively toward the positioning plate 300 to form the angles γ and δ, and then penetrate respectively through the first A hole 311 and the first B hole 312.

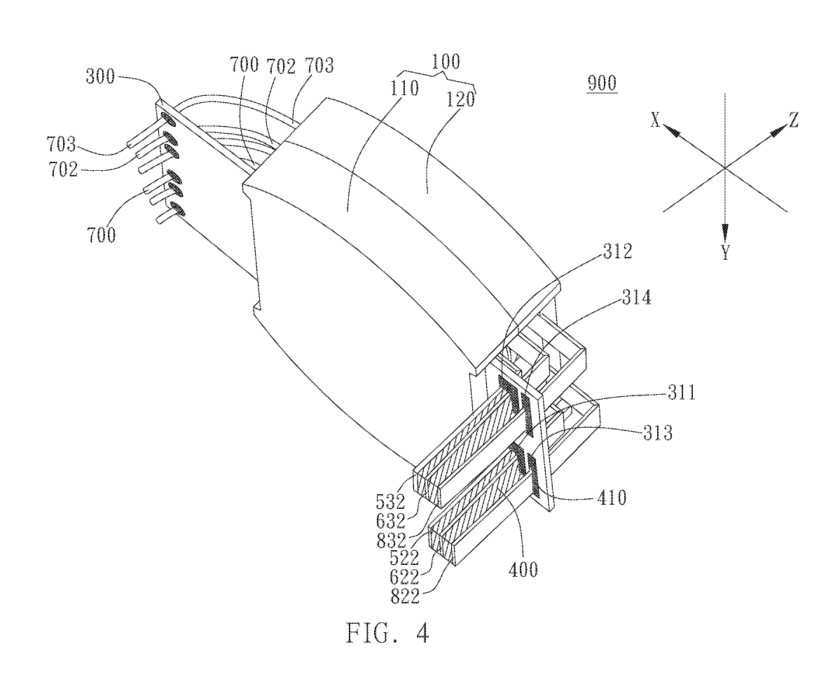

As shown in FIGS. 2A and 4, in a preferred embodiment, the first A, the first B, the third A, and the third B upper extending portions 521, 531, 621, and 631 all extend substantially along the X axis. Projections of the first A and the third A upper extending portions 521 and 621 in the direction of the Z axis at least partially overlap. Projections of the first B and the third B upper extending portions 531 and 631 in the direction of the Z axis at least partially overlap. The first A, the first B, the third A, and the third B lower extending portions 522, 532, 622, and 632 all extend substantially along the Z axis. Projections of the first A and the third A lower extending portions 522 and 622 in the direction of the X axis at least partially overlap. Projections of the first B and the third B lower extending portions 532 and 632 in the direction of the X axis at least partially overlap. Both the first A and the third A lower extending portions 522 and 622 penetrate through the first A hole 311. Both the first B and the third B lower extending portions 532 and 632 penetrate through the first B hole 312. As such, the first A lower extending portion 522 and the first B lower extending portion 532 are respectively closer to the third A lower extending portion 622 and the third B lower extending portion 632 to decrease the size of the first A hole 311 and the first B hole 312.

The first coil 500 and the third coil 600 can be connected in parallel in accordance with the application and design requirements. As the embodiment shown in FIG. 4, the first A and the third A lower extending portions 522 and 622 are welded together under the positioning plate 300 after penetrating through the first A hole 311, wherein the arrow direction of the Z axis is taken as the upper side in this figure. The first B and the third B lower extending portions 532 and 632 are welded together under the positioning plate 300 after penetrating through the first B hole 312. As such, the first coil 500 and the third coil 600 are connected in parallel. In this embodiment, the connection is achieved by using the solder material 400 in the soldering process. In different embodiments, however, the connection can be achieved by other approaches such as using conductive tapes.

The middle parts of the first A and the third A lower extending portions 522 and 622 are fixed on the positioning plate 300 by adhesive material after the first A and the third A lower extending portions 522 and 622 penetrate through the first A hole 311. The middle parts of the first B and the third B lower extending portions 532 and 632 are fixed on the positioning plate 300 by adhesive material 410 after the first B and the third B lower extending portions 532 and 632 penetrate through the first B hole 312. The adhesive material includes epoxy.

As the embodiment shown in FIGS. 2A and 4, the first A wire portion 520 extends along the X-Y plane, wherein the projection of the first A wire portion 520 on the X-Y plane has a first L shape. The third A wire portion extends 620 along the X-Z plane, wherein the projection of the third A wire portion 620 on the X-Z plane has a second L shape. The length of the third A upper extending portion 621 is larger than the length of the first A upper extending portion 521. The length of the third A lower extending portion 622 is larger than the length of the first A lower extending portion 522. The location of the third winding portion 610 is higher than the location of the first winding portion 510 in the accommodation space 101 for the third A wire portion 620 to extend above and outside the first A wire portion 520, wherein the first L shape and the second L shape have a substantially same bending angle, which is preferably 90 degrees.

As the embodiment shown in FIG. 2A, the voltage transformer 900 further includes a fourth coil 800 having a fourth winding portion 810, a fourth A wire portion 820, and a fourth B wire portion 830. As the embodiment shown in FIG. 3, the fourth winding portion 810 is accommodated in the accommodation space 101 and extends substantially along the X-Y plane. The rod portion 103 penetrates through the fourth winding portion 810. The first end portion 310 further has a third A hole 313 and a third B hole 314. The fourth A wire portion 820 has a fourth A upper extending portion 821 adjacent to the fourth winding portion 810 and a fourth A lower extending portion 822 penetrating through the third A hole 313, wherein a fifth angle c is included between the fourth A upper extending portion 821 and the fourth A lower extending portion 822. The fourth B wire portion 830 has a fourth B upper extending portion 831 adjacent to the fourth winding portion 810 and a fourth B lower extending portion 832 penetrating through the third B hole 314, wherein a sixth angle is included between the fourth B upper extending portion 831 and the fourth B lower extending portion 832.

As a preferred embodiment shown in FIGS. 2A and 4, the first A, the first B, the fourth A, and the fourth B upper extending portions 521, 531, 821, and 831 all extend substantially along the X axis. Projections of the first A and the fourth A upper extending portions 521 and 821 in the direction of the Z axis at least partially overlap. Projections of the first B and the fourth B upper extending portions 531 and 831 in the direction of the Z axis at least partially overlap. The first A, the first B, the fourth A, and the fourth B lower extending portions 522, 532, 822, and 832 all extend substantially along the Z axis. Projections of the first A and the fourth A lower extending portions 522 and 822 in the direction of the X axis at least partially overlap. Projections of the first B and the fourth B lower extending portions 532 and 832 in the direction of the X axis at least partially overlap.

In other words, in different embodiments, the lower extending portions of the coil are not limited to penetrating through the same positioning hole. As the embodiment shown in FIGS. 2A and 4, for example, both the first A and the third A lower extending portions 522 and 622 penetrate through the first A hole 311, and the fourth A lower extending portion 822 penetrates through the third A hole 313. Both the first B and the third B lower extending portions 532 and 632 penetrate through the first B hole 312, and the fourth B lower extending portion 832 penetrates through the third B hole 314. However, the extending portions can be overlapped as much as possible to decrease the gap between the extending portions, to make the appearance more compact, to assemble the transformer more conveniently, and to make the transformer have a better stability in quality.

The first coil 500 and the fourth coil 800 can be connected in parallel in accordance with the application and design requirements. As the embodiment shown in FIG. 4, the first A and the fourth A lower extending portions 522 and 822 are welded together under the positioning plate 300 after penetrating respectively through the first A hole 311 and the third A hole 313. The first B and the fourth B lower extending portions 532 and 832 are welded together under the positioning plate 300 after penetrating respectively through the first B hole 312 and the third B hole 314. The first winding portion 510 and the fourth winding portion 810 are connected in parallel. In this embodiment, the connection is achieved by using the solder material 400 in a soldering process. In different embodiments, however, the connection can be achieved by other approaches such as using conductive tapes.

The middle parts of the first A and the fourth A lower extending portions 522 and 822 are fixed on the positioning plate 300 by adhesive material after the first A and the fourth A lower extending portions 522 and 822 penetrate respectively through the first A hole 311 and the third A hole 313. The middle parts of the first B and the fourth B lower extending portions 532 and 832 are fixed on the positioning plate 300 by the same or different adhesive material after the first B and the fourth B lower extending portions 532 and 832 penetrate respectively through the first B hole 312 and the third B hole 314. The adhesive material includes epoxy.

As the embodiment shown in FIG. 4, the first A wire portion 520 extends along the X-Y plane and is bent toward the Z axis, so that the projection of the first A wire portion 520 on the X-Z plane has a first L shape. The fourth A wire portion 820 extends along the X-Y plane and is bent toward the Z axis, so that the projection of the fourth A wire portion 820 on the X-Z plane has a third L shape. The length of the fourth A upper extending portion 821 is larger than the length of the first A upper extending portion 521. The length of the fourth A lower extending portion 822 is larger than the length of the first A lower extending portion 522. As shown in FIG. 3, the location of the fourth winding portion 810 is higher than the location of the first winding portion 510 in the accommodation space 101 for the fourth A wire portion 820 to extend above and outside the first A wire portion 520, wherein the first L shape and the third L shape have a substantially same bending angle.

Taking a different point of view, the first coil 500, the third coil 600, and the fourth coil 800 can be seen as a first coil set, wherein the second coil 700, the fifth coil 702, and the sixth coil 703 can be seen as a second coil set. In a different embodiment, the number of coils included in the coil set can be modified in accordance with the application and design requirements, wherein the second coil 700, the fifth coil 702, and the sixth coil 703 can be connected either in series or in parallel. Moreover, the first A hole 311 of the positioning plate 300 and the first B hole 312 can be integrated into a single hole, wherein the third A hole 313 and the third B hole 314 can be integrated into a single hole, but not limited thereto.

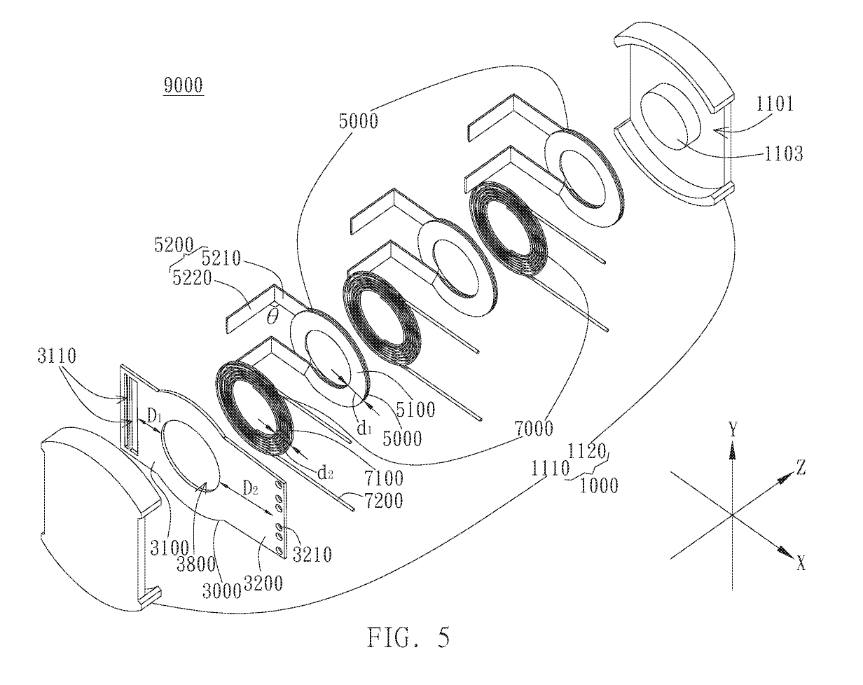

More particularly, as the embodiment shown in FIG. 5, the voltage transformer 9000 includes a magnetic core body 1000, a positioning plate 3000, a first coil set 5000, and a second coil set 7000. The magnetic core body 1000 has an accommodation space 1101 and a rod portion 1103 extending along the Z axis. The rod portion 1103 is surrounded with the accommodation space 1101. The positioning plate 3000 extends along the X-Y plane and has a first end portion 3100, a second end portion 3200, and a positioning hole 3800, wherein the first end portion 3100 has two first holes 3110. The rod portion 1103 penetrates through the positioning hole 3800. The X axis of the X-Y plane, the Y axis of the X-Y plane, and the Z axis are perpendicular to each other. The magnetic core body 1000 is composed of magnetic cores 1110 and 1120, wherein the magnetic cores 1110 and 1120 respectively have pillars and are with E-shaped cross section cutting along the Y axis through the pillars. When the pillars of the magnetic cores 1110 and 1120 abut upon each other, the pillars together form the rod portion 1103, wherein the space surrounds the rod portion 1103 between the magnetic cores 1110 and 1120 is the accommodation space 1101.

The first coil set 5000 includes at least one coil, wherein each coil has a first winding portion 5100 and a first wire portion 5200. The first winding portion 5100 is accommodated in the accommodation space 1101 and extends substantially along the X-Y plane. The rod portion 1103 penetrates through the first winding portion 5100. The first wire portion 5200 has a first part 5210 and a second part 5220, wherein an angle θ is included between the first part 5210 and the second part 5220. The second part 5220 penetrates through the first hole 3110. The second coil set 700 includes at least one coil, wherein each coil has a second winding portion 7100 and a second wire portion 7200. The second winding portion 7100 is accommodated in the accommodation space 1101 and extends substantially along the X-Y plane. The rod portion 1103 penetrates through the second winding portion 7100. The second wire portion 7200 protrudes toward the second end portion 3200 out of the magnetic core body 1000. The angle θ is, but not limited to, approximately 90 degrees.

As the embodiment shown in FIG. 5, there are a difference d₁ between the inner radius and the outer radius of the first coil set 5000 and a difference d₂ between the inner radius and the outer radius of the second coil set 7000, wherein the absolute value of d₁ minus d₂ is less than 1.5 mm, i.e. |d₁−d₂|<1.5 mm. The first coil set 5000 consists of M insulated flat wire coils. The second coil set 7000 consists of N trilayer insulated wire coils. M and N are positive integers. In this embodiment, M=3 and N=3. In different embodiments, however, M and N can be modified in accordance with the application and design requirements. In a preferred embodiment, the M insulated flat wire coils and the N trilayer insulated wire coils are alternatively arranged, i.e. the first coil set 5000 and the second coil set 7000 are substantially interlaced arranged. The first wire portions 5200 of the M insulated wire flat coils are overlapped, wherein M is larger than 1. The M insulated flat wire coils are electrically connected in parallel, wherein M is larger than 1.

As the embodiment shown in FIG. 5, the second end portion 3200 has a plurality of second holes 3210. The terminal ends of the second winding portion 7100 penetrate through the plurality of second holes 3210. A safety insulation distance D₂ is maintained between the second hole 3210 and the magnetic coil body 1000. The magnetic core body 1000 includes a first magnetic core 1110 and a second magnetic core 1120 both having an E-shaped profile.

As the embodiment shown in FIG. 5, the first coil set 5000 includes a plurality of coils formed by winding the insulated flat wire. The second coil set 7000 includes a plurality of coils formed by winding the trilayer insulated wire. In different embodiments, however, all of the coils included in the first coil set 5000 and the second coil set 7000 can be formed by winding the insulated flat wire or the trilayer insulated wire.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A voltage transformer, comprising:
a magnetic core body having an accommodation space and a rod portion extending along a Z axis, wherein the rod portion is surrounded with the accommodation space;
a positioning plate extending along an X-Y plane and having a first end portion, a second end portion, and a positioning hole, wherein the first end portion has a first A hole and a first B hole, wherein the rod portion penetrates through the positioning hole, wherein the X axis of the X-Y plane, the Y axis of the X-Y plane, and the Z axis are perpendicular to each other;
a first coil having a first winding portion, a first A wire portion, and a first B wire portion, wherein the first winding portion is accommodated in the accommodation space and extends substantially along the X-Y plane, wherein the rod portion penetrates through the first winding portion; and
a second coil having a second winding portion and a second wire portion, wherein the second winding portion is accommodated in the accommodation space and extends substantially along the X-Y plane, wherein the rod portion penetrates through the second winding portion, wherein the second wire portion protrudes toward the second end portion out of the magnetic core body;
wherein the first A wire portion has a first A upper extending portion adjacent to the first winding portion and a first A lower extending portion penetrating through the first A hole, wherein a first angle is included between the first A upper extending portion and the first A lower extending portion;
wherein the first B wire portion has a first B upper extending portion adjacent to the first winding portion and a first B lower extending portion penetrating through the first B hole, wherein a second angle is included between the first B upper extending portion and the first B lower extending portion.

2. The voltage transformer of claim 1, wherein the first A upper extending portion extends substantially along the X-Y plane, wherein the first A lower extending portion extends substantially along the Z axis, wherein the first angle between the first A upper extending portion and the first A lower extending portion is approximately 90 degrees.

3. The voltage transformer of claim 1, further comprising a third coil having a third winding portion, a third A wire portion, and a third B wire portion, wherein the third winding portion is accommodated in the accommodation space and extends substantially along the X-Y plane, wherein the rod portion penetrates through the third winding portion;
wherein the third A wire portion has a third A upper extending portion adjacent to the third winding portion and a third A lower extending portion penetrating through the first A hole, wherein a third angle is included between the third A upper extending portion and the third A lower extending portion;
wherein the third B wire portion has a third B upper extending portion adjacent to the third winding portion and a third B lower extending portion penetrating through the first B hole, wherein a fourth angle is included between the third B upper extending portion and the third B lower extending portion.

4. The voltage transformer of claim 3, wherein the first A, the first B, the third A, and the third B upper extending portions all extend substantially along the X axis, wherein projections of the first A and the third A upper extending portions in the direction of the Z axis at least partially overlap, wherein projections of the first B and the third B upper extending portions in the direction of the Z axis at least partially overlap.

5. The voltage transformer of claim 3, wherein the first A, the first B, the third A, and the third B lower extending portions all extend substantially along the Z axis, wherein projections of the first A and the third A lower extending portions in the direction of the X axis at least partially overlap, wherein projections of the first B and the third B lower extending portions in the direction of the X axis at least partially overlap.

6. The voltage transformer of claim 3, wherein the first A and the third A lower extending portions are welded together under the positioning plate after penetrating through the first A hole, wherein the first B and the third B lower extending portions are welded together under the positioning plate after penetrating through the first B hole, wherein the first winding portion and the third winding portion are connected in parallel.

7. The voltage transformer of claim 3, wherein middle parts of the first A and the third A lower extending portions are fixed on the positioning plate by adhesive material after the first A and the third A lower extending portions penetrate through the first A hole, wherein middle parts of the first B and the third B lower extending portions are fixed on the positioning plate by adhesive material after the first B and the third B lower extending portions penetrate through the first B hole.

8. The voltage transformer of claim 3, wherein the first A wire portion extends along the X-Z plane, wherein projection of the first A wire portion on the X-Z plane has a first L shape, wherein the third A wire portion extends along the X-Z plane, wherein projection of the third A wire portion on the X-Z plane has a second L shape, wherein the length of the third A upper extending portion is larger than the length of the first A upper extending portion, wherein the length of the third A lower extending portion is larger than the length of the first A lower extending portion, wherein the location of the third winding portion is higher than the location of the first winding portion in the accommodation space for the third A wire portion to extend above and outside the first A wire portion, so that the first L shape and the second L shape have a substantially same bending angle.

9. The voltage transformer of claim 1, further comprising a fourth coil having a fourth winding portion, a fourth A wire portion, and a fourth B wire portion, wherein the fourth winding portion is accommodated in the accommodation space and extends substantially along the X-Y plane, wherein the rod portion penetrates through the third winding portion, wherein the first end portion further has a third A hole and a third B hole;
wherein the fourth A wire portion has a fourth A upper extending portion adjacent to the fourth winding portion and a fourth A lower extending portion penetrating through the third A hole, wherein a fifth angle is included between the fourth A upper extending portion and the fourth A lower extending portion;
wherein the fourth B wire portion has a fourth B upper extending portion adjacent to the fourth winding portion and a fourth B lower extending portion penetrating through the third B hole, wherein a sixth angle is included between the fourth B upper extending portion and the fourth B lower extending portion.

10. The voltage transformer of claim 9, wherein the first A, the first B, the fourth A, and the fourth B upper extending portions all extend substantially along the X axis, wherein projections of the first A and the fourth A upper extending portions in the direction of the Z axis at least partially overlap, wherein projections of the first B and the fourth B upper extending portions in the direction of the Z axis at least partially overlap.

11. The voltage transformer of claim 9, wherein the first A, the first B, the fourth A, and the fourth B lower extending portions all extend substantially along the Z axis, wherein projections of the first A and the fourth A lower extending portions in the direction of the X axis at least partially overlap, wherein projections of the first B and the fourth B lower extending portions in the direction of the X axis at least partially overlap.

12. The voltage transformer of claim 9, wherein:
the first A and the fourth A lower extending portions are welded together under the positioning plate after penetrating respectively through the first A hole and the third A hole;
the first B and the fourth B lower extending portions are welded together under the positioning plate after penetrating respectively through the first B hole and the third B hole, wherein the first winding portion and the fourth winding portion are connected in parallel.

13. The voltage transformer of claim 9,
wherein middle parts of the first A and the fourth A lower extending portions are fixed on the positioning plate by adhesive material after the first A and the fourth A lower extending portions penetrate respectively through the first A hole and the third A hole;
wherein middle parts of the first B and the fourth B lower extending portions are fixed on the positioning plate by adhesive material after the first B and the fourth B lower extending portions penetrate respectively through the first B hole and the third B hole.

14. The voltage transformer of claim 9, wherein the first A wire portion extends along the X-Z plane, wherein projection of the first A wire portion on the X-Z plane has a first L shape, wherein the fourth A wire portion extends along the X-Z plane, wherein projection of the fourth A wire portion on the X-Z plane has a third L shape, wherein the length of the fourth A upper extending portion is larger than the length of the first A upper extending portion, wherein the length of the fourth A lower extending portion is larger than the length of the first A lower extending portion, wherein the location of the fourth winding portion is higher than the location of the first winding portion in the accommodation space for the fourth A wire portion to extend above and outside the first A wire portion, so that the first L shape and the third L shape have a substantially same bending angle.

15. The voltage transformer of claim 1, wherein the second winding portion includes a first-layered structure and a second-layered structure in the direction of the Z axis, wherein the second coil is wound by: (1) winding an insulated wire on the X-Y plane to form the first-layered structure, wherein an inner rim of the first-layered structure is aligned with an inner rim of the first winding portion, wherein an outer rim of the first-layered structure is close to an outer rim of the first winding portion; (2) changing position of the tail of the insulated wire in the direction of the Z axis to wind the second-layered structure, wherein an inner rim of the second-layered structure is aligned with the inner rim of the first winding portion, wherein an outer rim of the second-layered structure is close to the outer rim of the first winding portion.

16. A voltage transformer, comprising:
a magnetic core body having an accommodation space and a rod portion extending along a Z axis, wherein the rod portion is surrounded with the accommodation space;
a positioning plate extending along an X-Y plane and having a first end portion, a second end portion, and a positioning hole, wherein the first end portion has two first holes, wherein the rod portion penetrates through the positioning hole, wherein the X axis of the X-Y plane, the Y axis of the X-Y plane, and the Z axis are perpendicular to each other;
a first coil set including at least one first coil, wherein each first coil has a first winding portion and a first wire portion, wherein the first winding portion is accommodated in the accommodation space and extends substantially along the X-Y plane, wherein the rod portion penetrates through the first winding portion, wherein the first wire portion has a first part and a second part, wherein an angle is included between the first part and the second part, wherein the second part penetrates through the first hole; and
a second coil set including at least one second coil, wherein each second coil has a second winding portion and a second wire portion, wherein the second winding portion is accommodated in the accommodation space and extends substantially along the X-Y plane, wherein the rod portion penetrates through the second winding portion, wherein the second wire portion protrudes toward the second end portion out of the magnetic core body.

17. The voltage transformer of claim 16, wherein the difference between the inner and outer radiuses of the first coil set is d₁, wherein the difference between the inner and outer radiuses of the second coil set is d₂, the absolute value of d₁ minus d₂ (Idi-d₂₁) is less than 1.5 mm.

18. The voltage transformer of claim 16, wherein the first coil set consists of M insulated flat wire coils, wherein the second coil set consists of N trilayer insulated wire coils, wherein M and N are positive integers.

19. The voltage transformer of claim 18, wherein the M insulated flat wire coils and the N trilayer insulated wire coils are alternatively arranged.

20. The voltage transformer of claim 18, wherein the first wire portions of the M insulated flat wire coils are overlapped, wherein M is larger than 1.

21. The voltage transformer of claim 18, wherein the M insulated flat wire coils are electrically connected in parallel, wherein M is larger than 1.

22. The voltage transformer of claim 16, wherein the second end portion has a plurality of second holes, wherein the terminal ends of the second winding portion penetrate through the plurality of second holes, wherein a safety insulation distance is maintained between the second hole and the magnetic coil.

23. The voltage transformer of claim 16, wherein the magnetic core body includes a first magnetic core and a second magnetic core both having an E-shaped profile.

24. The voltage transformer of claim 16, wherein the first coil is formed by an insulated flat wire, wherein the second coil is formed by a trilayer insulated wire.

25. The voltage transformer of claim 16, wherein the angle between the first part and the second part is approximately 90 degrees.

26. The voltage transformer of claim 16, wherein the second winding portion includes a first-layered structure and a second-layered structure in the direction of the Z axis, wherein the second coil is wound by: (1) winding an insulated wire on the X-Y plane to form the first-layered structure, wherein an inner rim of the first-layered structure is aligned with an inner rim of the first winding portion, wherein an outer rim of the first-layered structure is close to an outer rim of the first winding portion; (2) changing position of the tail of the insulated wire in the direction of the Z axis to wind the second-layered structure, wherein an inner rim of the second-layered structure is aligned with the inner rim of the first winding portion, wherein an outer rim of the second-layered structure is close to the outer rim of the first winding portion.
